(19) United States
(12) Patent Application Publication
(10) Pub. No.: US 2025/0006086 A1
(43) Pub. Date: Jan. 2, 2025

(54) Child-Friendly Art Display and Creation System

(71) Applicant: Dane Mwirigi Kiambi, Lincoln, NE (US)

(72) Inventor: Dane Mwirigi Kiambi, Lincoln, NE (US)

(21) Appl. No.: 18/236,412

(22) Filed: Aug. 22, 2023

Related U.S. Application Data
(60) Provisional application No. 63/524,233, filed on Jun. 30, 2023.

(51) Int. Cl. G09F 13/04; G09F 7/18

(52) U.S. Cl. CPC G09F 13/0445; G09F 7/18; G09F 2007/1852

(57) ABSTRACT

The present invention relates to a child-friendly art display and creation system known as the ArtBoard. Comprising a flat front surface for mounting children's art pieces, the invention includes child-safe edges and a magnetic mounting system that allows for independent positioning by children. The front of the board offers attachment means through pins or magnets, providing ease of use. Advanced versions include a removable glass or plastic cover, customizable integrated lighting elements, and storage compartments for art supplies. The ArtBoard offers various customization options and is constructed from eco-friendly recycled materials. The invention significantly enhances the display and creation of children's artwork, offering a multifunctional solution that combines safety, aesthetics, versatility, and environmental responsibility.

### CROSS REFERENCE TO RELATED APPLICATIONS

This patent application claims the benefit of U.S. Provisional Patent Application No. 63/524,233, filed 30 Jun. 2023.

### FIELD OF INVENTION

The present invention relates generally to art display and creation systems and, more specifically, to a child-friendly art board designed to facilitate both the mounting and creation of children's art pieces, with integrated storage and lighting features.

### BACKGROUND

Children's creativity is often nurtured through drawing, painting, and crafting, leading to an abundance of artwork that parents and caregivers seek to display and preserve.

Traditional systems for displaying children's artwork have several drawbacks: Standard cork bulletin boards require the use of pushpins, which can pose a safety risk to young children. Additionally, the aesthetic appeal is often lacking, and they do not provide a means for children to independently and easily attach or remove their art pieces. While magnetic boards eliminate the need for pins, they often use strong magnets that can be difficult for young children to manipulate. They also lack features to enhance the presentation of the artwork, such as lighting effects or customizable decorations. Taping art to walls or refrigerators can damage both the artwork and the surfaces to which they are attached. This method also lacks versatility in positioning and relocating the art.

Furthermore, many existing systems fail to provide integrated storage for art supplies, leading to disorganization and lost materials, which can stifle a child's creative process. Many conventional art display systems are made from non-recyclable materials, contributing to environmental concerns. Pre-existing solutions often lack customization in terms of size, shape, color, or decoration, leading to a lack of personalization that may not engage the child's interest.

Recognizing the above shortcomings, there exists a need for a safe, versatile, engaging, and environmentally responsible system that facilitates both the creation and display of children's artwork. The motivations for developing the present invention include enhancing safety by creating child-safe edges and attachment mechanisms. The invention aims to minimize risks associated with traditional methods while fostering independence through easy-to-use magnetic mounting systems. By enabling children to independently handle and interact with their art displays, the invention improves aesthetics. The inclusion of customizable lighting effects and decorations offers a more visually appealing display. The invention also encourages organization through integrated storage compartments, which provide easy access to art supplies, promoting a more streamlined creative process. Eco-friendly considerations are also addressed by constructing the invention from recycled materials.

It is within this context that the present invention is provided.

### SUMMARY

The present disclosure provides a child-friendly art display and creation system known as the ArtBoard. It offers a unique solution to the challenges associated with traditional art display systems, combining safety, aesthetics, versatility, engagement, and environmental responsibility.

In one aspect, the ArtBoard comprises a flat front surface suitable for mounting children's art pieces, surrounded by child-safe edges. The board is equipped with a magnetic mounting system at the back, enabling children to independently position and relocate the board at their convenience. The magnetic mounting system can be arranged either with magnets in all four corners or with a single large magnet in the center.

In another aspect, the front of the board allows for easy attachment of the child's art pieces through two distinct methods. One method employs pins that can be effortlessly inserted into a sponge-like material on the front of the board. The other method uses magnets attracted to a light metallic sheet or any other magnet attracting material embedded within the board. These options provide flexibility and ease of use for attaching art pieces.

The invention further encompasses advanced versions that include a removable glass or plastic cover with a locking mechanism that an adult can release, and integrated lighting elements placed behind the board surface. These lighting elements can be connected to an electrical outlet and are designed to create customizable lighting effects with different colors, intensity levels, or dynamic lighting patterns.

Additionally, the ArtBoard incorporates integrated storage compartments or holders to house art supplies such as markers, colored pencils, or paintbrushes. This ensures that children have easy access to their creative tools.

In terms of construction, the ArtBoard is made from eco-friendly recycled materials. It also provides customization options in colors, sizes, shapes, and decorations on the edges that surround the board.

The invention is designed to be adaptable for homes, schools, and other environments where children's creativity is encouraged and facilitated.

### BRIEF DESCRIPTION OF THE DRAWINGS

Various embodiments of the invention are disclosed in the following detailed description and accompanying drawings.

FIG. 1A illustrates an isometric front view of the first embodiment of the Light board, designed for use with pins, showing the rectangular profile, spongelike material, integrated art supply holders, customizable edge decorations, and a light metal sheet backing.

FIG. 1B presents an isometric rear view of the first embodiment, depicting the various magnet mounting options including corner, central, and side magnets.

FIG. 2 shows an isometric front view of the second embodiment of the Light board, designed for use with magnets, highlighting the flat front surface made of a lightweight metallic sheet covered with a protective material.

FIG. 3 portrays an isometric front view of the third embodiment of the Light board, the advanced version with a glass or plastic cover and integrated lighting, including a locking mechanism and an electric line for power connection.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The ArtBoard comprises a flat front surface that serves as a mounting area for children's art pieces. The edges surrounding this front surface are designed to be child-safe, eliminating sharp or hazardous components that could harm young users.

The back of the ArtBoard is equipped with a magnetic mounting system that allows children to independently position and relocate the board throughout their living space. The magnetic mounting system can be configured with magnets in all four corners of the board or with a single large magnet in the center. This flexibility ensures easy handling by children, promoting a sense of independence and control over their creative environment.

The invention includes two distinct attachment methods for securing art pieces to the front surface. The first method uses pins that can be effortlessly inserted into a sponge-like material. The second method employs magnets attracted to a light metallic sheet or any other magnet attracting material embedded within the board. These two options cater to different preferences and provide flexibility for children and parents alike.

In some embodiments, the ArtBoard includes a removable glass or plastic cover that can be locked and unlocked using a mechanism accessible only by an adult. This cover adds an extra layer of protection to the artwork.

The invention may also feature integrated lighting elements positioned behind the board surface. When connected to an electrical outlet, these lighting elements can illuminate the artwork, offering customizable effects such as varying colors, intensity levels, and dynamic patterns. This unique feature adds a visually engaging and immersive experience.

The ArtBoard is designed with various customization options. These include different colors, sizes, shapes, and decorations on the edges surrounding the board. The availability of these options allows the system to be tailored to the specific tastes and preferences of individual children.

Some embodiments include integrated storage compartments or holders designed to house art supplies such as markers, colored pencils, or paintbrushes. This organization feature ensures that children have easy access to their tools, fostering a more seamless creative process.

Referring now to the drawings:

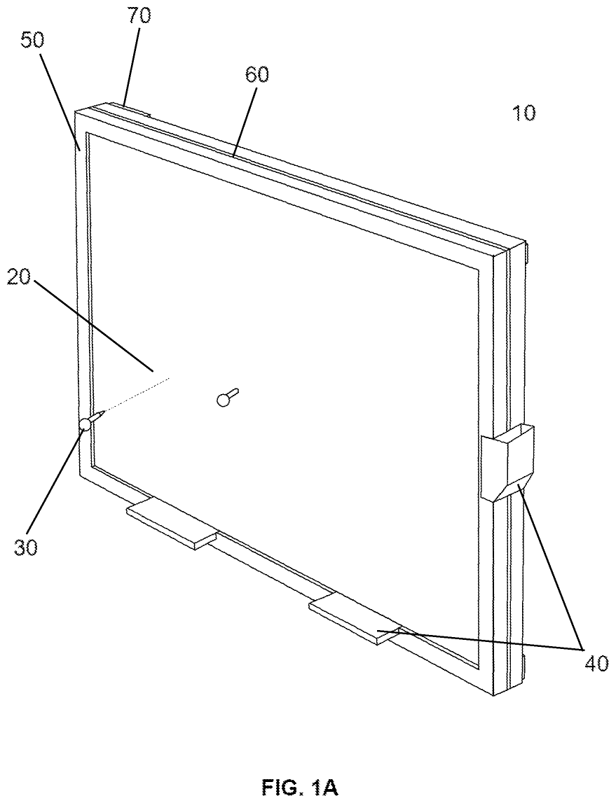

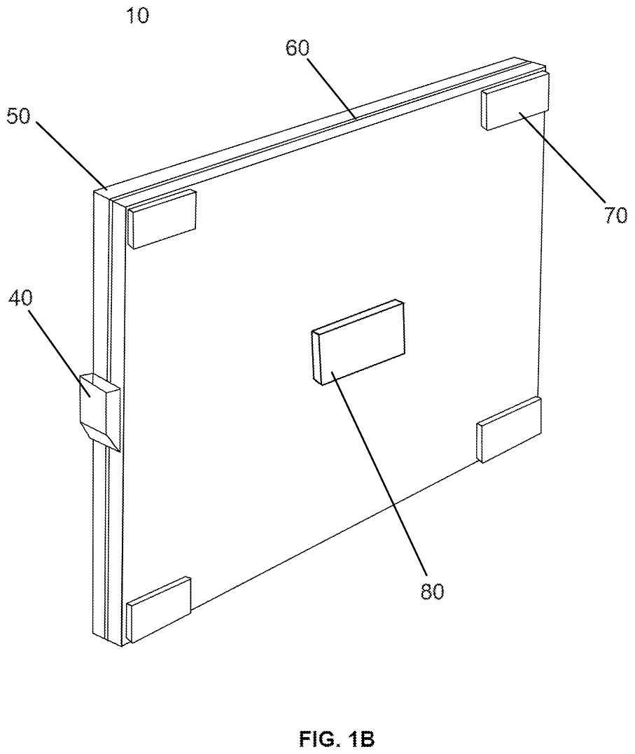

FIG. 1A—Isometric Front View of the First Embodiment (for Use with Pins)

FIG. 1A illustrates an isometric front view of the first embodiment of the Light board, specifically designed for use with pins. It depicts the rectangular profile of the artboard (10), which serves as the main structure for mounting and displaying children's artwork. Covering the front surface is a spongelike material (20) that facilitates the use of pins (30) to secure art pieces and provides a cushioned layer for effortless pin insertion. Integrated holders (40) for art supplies are mounted to the edges of the board, offering convenient storage and easy access to art tools such as markers, colored pencils, or paintbrushes. The edges of the board (50), can be adorned with various customizable decorations to enhance aesthetics and appeal to individual preferences. Behind the front surface, a light metal sheet (60) adds structural stability to the board and provides a basis for easy switching to the use of magnetic mounting pins, enhancing the versatility of the system.

FIG. 1B—Isometric Rear View of the First Embodiment (for Use with Pins)

FIG. 1B presents an isometric rear view of the first embodiment of the Light board. It shows the mounting magnets (70) on each corner of the board, enabling easy attachment of the board to various surfaces within children's reach. Also depicted is a large central magnet (80), positioned in the middle of the board, offering an alternative mounting option. In some examples, the board may feature only corner magnets, while in others, only a central magnet may be used. Side magnets (80) can be used in conjunction with or instead of corner and central magnets, providing additional flexibility in mounting the board.

Together, FIGS. 1A and 1B provide a comprehensive understanding of the first embodiment of the Light board, focusing on the pin-usage design. They showcase the structural components, functional features, and aesthetic attributes that contribute to the child-friendly, versatile, and visually engaging nature of the invention.

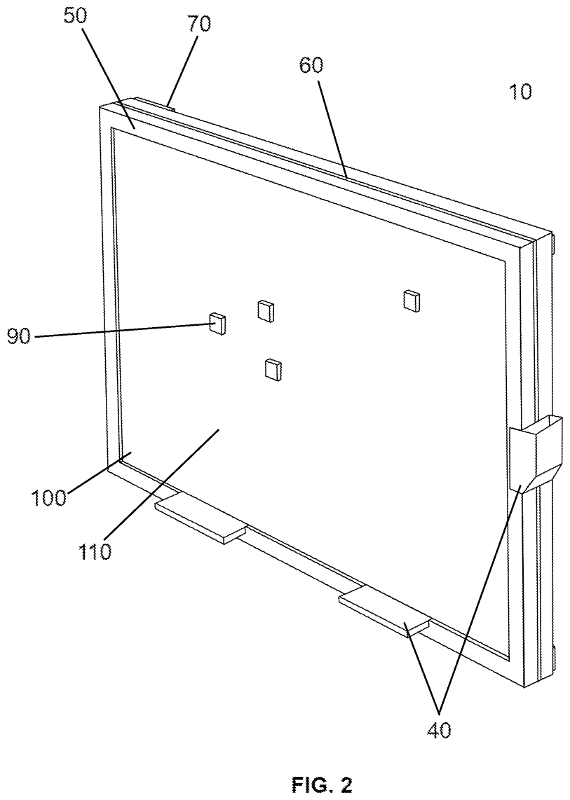

FIG. 2—Isometric Front View of the Second Embodiment (for Use with Magnets)

FIG. 2 illustrates an isometric front view of the second embodiment of the Light board, designed for use with magnets (90). It displays the flat front surface of the board (100). As in the first embodiment, the board comprises an integrated lightweight metallic sheet (60) but which is now covered with a non-spongelike cover material (110) to prevent scratching. The cover material can be a cloth-like substance or any other suitable material that maintains the aesthetic appeal of the board while protecting the metallic sheet. The rear of this second embodiment is identical to the first embodiment as previously described in FIG. 1B, utilizing corner magnets (70), central magnet (80) for mounting.

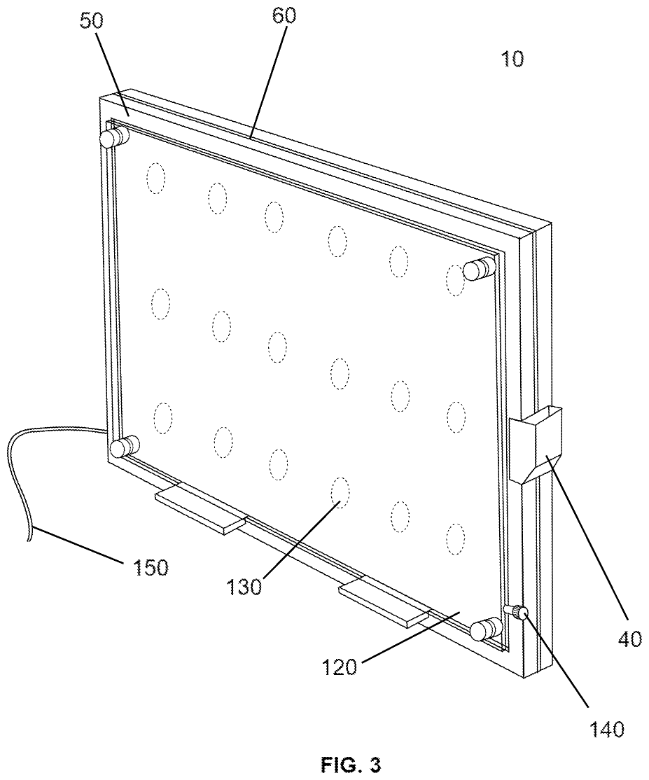

FIG. 3—Isometric Rear View of the Third Embodiment (Advanced Version with Glass or Plastic Cover and Integrated Lighting)

FIG. 3 presents an isometric front view of the third embodiment of the Light board, which is the advanced version, complete with a glass or plastic cover and integrated lighting. It showcases the removable glass or plastic cover (120) and integrated lighting elements (130) behind the board surface. These lighting elements can be customized to offer different colors, intensity levels, or dynamic patterns, enhancing the visual experience of the displayed artwork. A locking mechanism with a control knob (140) is positioned on the board to enable an adult to securely open and close the glass or plastic cover, ensuring child safety. Additionally, an electric line to connect to power (150) is included, providing the necessary energy to the lighting elements for illumination

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the artboard device have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An art display and creation system for children, comprising:
a board with a flat front surface for mounting children's art pieces,
child-safe edges surrounding said front surface,
a magnetic mounting system at the back enabling independent positioning and relocation, and
and attachment means on the front of the board for securing children's art pieces.

2. The system of claim 1, wherein said attachment means includes pins that can be inserted into a sponge-like material covering the flat front surface of the board.

3. The system of claim 1, wherein said attachment means includes magnets attracted to a light metallic sheet or any other magnet attracting material embedded within the board.

4. The system of claim 1, wherein said magnetic mounting system comprises magnets arranged at the rear edges and/or corners of the board.

5. The system of claim 1, wherein said magnetic mounting system comprises a single large magnet arranged at the center of the board rear.

6. The system of claim 1, further comprising a removable glass or plastic cover with a locking mechanism.

7. The system of claim 1, further comprising integrated lighting elements placed behind the board surface and a connection to a power supply.

8. The system of claim 6, further comprising a controller and interface configured to cause said integrated lighting elements to produce customizable lighting effects with different colors, variable intensity levels, and dynamic lighting patterns.

9. The system of claim 1, further comprising integrated storage compartments or holders for art supplies mounted on the child-safe edges.

10. The system of claim 1, further comprising customizable design elements on the child-safe edges.

11. The system of claim 1, wherein said system is customizable in color, size, and shape.

12. The system of claim 1, wherein the display and creation system is constructed from eco-friendly recycled materials
